(19) United States
(12) Patent Application Publication
(10) Pub. No.: US 2024/0411138 A1
(43) Pub. Date: Dec. 12, 2024

(54) LENS TINTING FOR INTEGRATED LENS DISPLAY

(71) Applicant: GOOGLE LLC, Mountain View, CA (US)

(72) Inventors: Daniel Adema, Kitchener (CA); Syed Moez Haque, Vaughan (CA); Thuy Hong Nguyen, Waterloo (CA); Brian Watson Cranton, Kitchener (CA); Lloyd Frederick Holland, Kitchener (CA)

(21) Appl. No.: 18/717,960

(22) PCT Filed: Nov. 21, 2022
(86) PCT No.: PCT/US2022/050547

§ 371 Date: Jun. 7, 2024

Related U.S. Application Data
(60) Provisional application No. 63/288,227, filed on Dec. 10, 2021.

(51) Int. Cl. G02B 27/01

(52) U.S. Cl. CPC G02B 27/0172; G02B 2027/0118

(57) ABSTRACT

The present disclosure describes tinting techniques in a lens stack assembly for a wearable head mounted display (WHMD). The lens stack assembly includes a waveguide disposed between two lenses, where the two lenses include tints to selectively reduce the amount of ambient light transmitted to the user while not reducing the amount of the display light in the WHMD. In addition, the tinting techniques described herein reduce or eliminate the generation of ghost images resulting from the reflection of outcoupled light from the waveguide away from the user back toward the user.

### BACKGROUND

Wearable head-mounted displays (WHMDs) utilize a projector to emit a pattern of light to display an image or video. For example, the projector typically emits this pattern of light (referred to as display light) to a waveguide, which incouples the display light at an incoupler, guides the display light via one or more instances of total internal reflection (TIR) through the waveguide, and outcouples the display light in the direction of a user via an outcoupler. In addition to projecting the display light to the user, WHMDs such as those used in augmented reality (AR) or mixed reality (MR) allow the user to observe their surrounding environment through the optical see-through lenses of the WHMD. For example, ambient light from sources external to the WHMD (i.e., light that is not generated by the projector of the WHMD) passes through the lenses of the WHMD to the user. Conventional WHMDs attempt to reduce the amount of ambient light that reaches the user to increase the ratio of display light relative to ambient light by applying tints to the lenses of the WHMD. However, conventional tinting techniques can interfere with the display light, thereby reducing the quality of the displayed image and negatively impacting the user experience.

### SUMMARY

In a first example embodiment, a lens stack assembly includes a waveguide disposed between a first lens and a second lens, the waveguide configured to incouple display light at an incoupler and outcouple the display light at an outcoupler. A tint is applied at the second lens and has a first level of light transmission for light with a first optical characteristic associated with the display light and a lower, second level of light transmission for light with a second optical characteristic.

In some aspects of the first example embodiment, the first optical characteristic includes a first wavelength range, and the second optical characteristic includes wavelengths outside of the first wavelength range.

In some aspects of the first example embodiment, the first optical characteristic includes a first polarization state, and the second optical characteristic includes a second polarization state different than the first polarization state. The tint is polarization selective to transmit light with the first polarization state and block light with the second polarization state.

In some aspects of the first example embodiment, the tint is a bulk tint incorporated into a substrate of the first lens.

In some aspects of the first example embodiment, the tint is a surface coating tint applied to a major surface of the first lens.

In some aspects of the first example embodiment, the tint is a gradient tint with a gradient along a first direction on the major surface of the first lens or in a second direction traversing a thickness of the first lens.

In some aspects of the first example embodiment, the tint is a photochromic tint or an electrochromic tint. For example, in some aspects, the tint changes based on one or more environmental factors to alter the second level of light transmission.

In some aspects of the first example embodiment, the first lens is a world-side lens, and the second lens is an eye-side lens to be closer to a user than the first lens.

In some aspects of the first example embodiment, the second optical characteristic is associated with ambient light from a source external to a wearable head mounted display (WHMD) comprising the lens stack assembly.

In a second example embodiment, the lens stack assembly includes a waveguide disposed between a first lens and a second lens, the waveguide configured to incouple display light at an incoupler and outcouple the display light at an outcoupler, wherein the first lens is a world-side lens and the second lens is a user eye-side lens, where the first lens includes a tint to absorb light received from the waveguide.

In some aspects of the second example embodiment, the tint absorbs light with a first optical characteristic associated with the display light. In some aspects of the second example embodiment, the first optical characteristic is a first wavelength range.

In some aspects of the second example embodiment, the tint at least partially blocks light with a second optical characteristic that is not associated with the display light. In some aspects of the second example embodiment, the at least partially blocking of light with the second optical characteristic includes reflecting or absorbing. In some aspects of the second example embodiment, the second optical characteristic is associated with ambient light entering the lens stack assembly via the first lens.

In some aspects of the second example embodiment, the tint includes a bulk tint incorporated into a substrate of the first lens.

In some aspects of the second example embodiment, the tint includes a surface coating tint applied to a major surface of the first lens.

In some aspects of the second example embodiment, the tint includes a gradient tint with a gradient along a first direction on the major surface of the first lens or in a second direction traversing a thickness of the first lens.

In some aspects of the second example embodiment, the tint includes a photochromic tint or an electrochromic tint, wherein the second level of light transmission changes based on one or more environmental factors.

In a third example embodiment, a method to control light in a WHMD, the WHMD with a lens stack assembly including a waveguide disposed between a world-side lens and an eye-side lens is described. The method includes incoupling display light at an incoupler of the waveguide, outcoupling a first portion of the incoupled display light to a user through the eye-side lens and absorbing a second portion of the incoupled display light at the world-side lens.

In some aspects of the third example embodiment, a tint at the world-side lens absorbs light with a first optical characteristic associated with the display light.

In some aspects of the third example embodiment, the first optical characteristic is a wavelength range, and the tint is further configured to at least partially block light with a second optical characteristic including a second wavelength range associated with an ambient light from a source external to the WHMD.

In a fourth example embodiment, a method to control light in a WHMD, the WHMD with a lens stack assembly including a waveguide disposed between a world-side lens and an eye-side lens is described. The method includes incoupling display light with a first optical characteristic at an incoupler, outcoupling the incoupled display light to a user through the eye-side lens, wherein a tint at the eye-side lens has a first level of light transmission for the first optical characteristic, and at least partially blocking ambient light from an external source of the WHMD at the eye-side lens, wherein the tint at the eye-side lens has a second level of light transmission, lower than the first level of light transmission, for a second optical characteristic that is associated with the ambient light.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows a diagram of an example display system having a support structure that houses a projection system configured to project images toward the eye of a user, in accordance with some embodiments.

FIG. 2 shows a diagram of an example of a portion of a WHMD that displays display light from a projector and ambient light from the surrounding environment, in accordance with some embodiments.

FIG. 3 shows a diagram of a lens stack assembly, in accordance with some embodiments.

FIG. 4 shows a diagram of a lens stack assembly with a selective tint applied to an eye-side lens, in accordance with some embodiments.

FIG. 5 shows a diagram illustrating the generation of ghost images.

FIG. 6 shows a diagram of a lens stack assembly with an absorptive tint applied to a world-side lens to mitigate or eliminate ghost images, in accordance with some embodiments.

FIG. 7 shows a diagram of a lens stack assembly with a polarization-selective tint applied to a world-side lens to mitigate or eliminate ghost images, in accordance with some embodiments

FIG. 8 shows a flowchart illustrating a method for a WHMD to control light to eliminate the generation of ghost images in a WHMD, in accordance with some embodiments.

FIG. 9 shows a flowchart illustrating a method for a WHMD to selectively block ambient light, in accordance with some embodiments.

### DETAILED DESCRIPTION

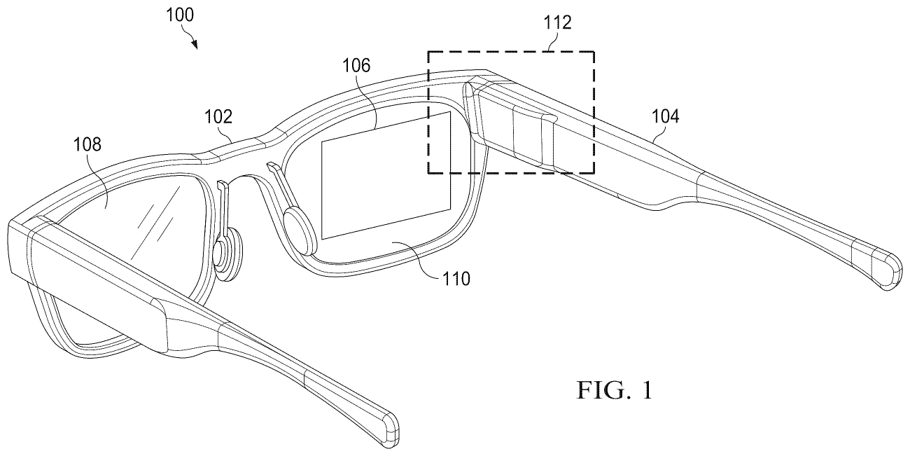

Lenses in conventional WHMDs may be tinted to reduce the amount of ambient light that reaches the user's eye to increase the relative proportion of display light of the total light including the display light and the ambient light that the user is able to observe. However, when implemented into a lens stack assembly with an integrated optical see-through display such as a waveguide, the tint in tinted lenses can interfere with the display light. For example, a conventional tint applied to the eye-side lens in a lens stack assembly (e.g., to a lens between a waveguide and a user) can, in addition to reducing the brightness or intensity of the ambient light, also reduce the brightness or intensity of the display light, negatively impacting the quality of this displayed image. The effects of the tinting can be overcome by increasing the brightness of the display light, but this approach leads to higher power consumption by the WHMD. Furthermore, a conventional reflective tint applied to the world-side lens (i.e., to a lens between the waveguide and the outside world) to reflect incoming ambient light can also reflect a portion of the display light that is outcoupled from the waveguide away from the user back in the direction of the user. This results in ghost images that degrade the quality of the image delivered to the user. FIGS. 1-9 illustrate techniques for applying tints in a lens stack assembly to selectively block ambient light without negatively impacting the quality of the images generated by the display light, thereby improving the user experience.

To illustrate, in some embodiments a lens stack assembly includes a waveguide disposed between a first lens and a second lens. The first lens is configured as a world-side lens facing the user's external environment and the second lens is configured as an eye-side lens facing the user. In some embodiments, the eye-side lens includes a tint with a first level of light transmission for a first optical characteristic associated with the display light and a second, lower level of light transmission for other optical characteristics not associated with the display light. For example, the tint does not block light of a first wavelength range associated with the display light and at least partially blocks light of a second wavelength range associated with ambient light. Accordingly, the quality (e.g., the brightness) of the display light remains largely unaffected while the ambient light that reaches the user's eye is reduced, thereby increasing the visibility of the images produced by the display light. In some embodiments, the world-side lens includes an absorptive tint to absorb light that is outcoupled from the waveguide in a direction away from the user. Thus, the generation of ghost images is reduced or eliminated altogether, thereby improving the image quality delivered to the user.

FIGS. 1-9 illustrate embodiments of a tinted lens stack assembly and corresponding tinting techniques to provide a WHMD that selectively blocks ambient light and reduces ghost images. Within this disclosure, the term “tint” or similar terminology generically refers to a kind of optical attenuation method. This includes, for example, the addition of a colorant to a white, the addition of a black to a colorant to darken it (i.e., shade), adding a polarization filter such as a grid polarizer to selectively filter light based on polarization states, or the like. However, it will be appreciated that the apparatuses and techniques of the present disclosure are not limited to implementation in this particular display system, but instead may be implemented in any of a variety of display systems using the guidelines provided herein.

FIG. 1 illustrates an example display system 100 having a support structure 102 that includes an arm 104, which houses a projection system configured to project images toward the eye of a user, such that the user perceives the projected images as being displayed in a field of view (FOV) area 106 of a display at one or both of lens elements 108, 110. In the depicted embodiment, the display system 100 is a WHMD that includes a support structure 102 configured to be worn on the head of a user and has a general shape and appearance of an eyeglasses (e.g., sunglasses) frame. The support structure 102, including the lens elements 108, 110, contains or otherwise includes various components to facilitate the projection of such images toward the eye of the user, such as a laser projector, an optical scanner, and a waveguide. In some embodiments, the support structure 102 further includes various sensors, such as one or more front-facing cameras, rear-facing cameras, other light sensors, motion sensors, accelerometers, and the like. In some embodiments, the support structure 102 further includes one or more radio frequency (RF) interfaces or other wireless interfaces, such as a Bluetooth™ interface, a WiFi interface, and the like. Further, in some embodiments, the support structure 102 further includes one or more batteries or other portable power sources for supplying power to the electrical components of the display system 100. In some embodiments, some or all of these components of the display system 100 are fully or partially contained within an inner volume of support structure 102, such as within the arm 104 in region 112 of the support structure 102. It should be noted that while an example form factor is depicted, it will be appreciated that in other embodiments the display system 100 may have a different shape and appearance from the eyeglasses frame depicted in FIG. 1.

One or both of the lens elements 108, 110 are used by the display system 100 to provide an augmented reality (AR) display in which rendered graphical content can be superimposed over or otherwise provided in conjunction with a real-world view as perceived by the user through the lens elements 108, 110. For example, projected light beams (i.e., display light) used to form a perceptible image or series of images may be projected by a projector of the display system 100 onto the eye of the user via a series of optical elements, such as a waveguide formed at least partially in the corresponding lens element, one or more scan mirrors, and one or more optical relays. One or both of the lens elements 108, 110 thus include at least a portion of a waveguide that routes display light received by an incoupler of the waveguide to an outcoupler of the waveguide, which outputs the display light toward an eye of a user of the display system 100. In some embodiments, the outcoupler at least partially overlaps the FOV area 106. The display light is modulated and scanned onto the eye of the user such that the user perceives the display light as an image. In addition, each of the lens elements 108, 110 is sufficiently transparent to allow a user to see through the lens elements to provide a field of view of the user's real-world environment such that the image appears superimposed over at least a portion of the real-world environment.

In some embodiments, one or both of the lens elements 108, 110 includes a lens stack assembly with a waveguide disposed between a first lens and a second lens. For example, the first lens is a world-side lens, and the second lens is an eye-side lens facing the user. In some embodiments, the second (i.e., the eye-side) lens includes a tint with a first level of light transmission for a first optical characteristic associated with the display light and a lower, second level of light transmission for other optical characteristics that are not associated with the display light, e.g., light that is associated with ambient light from the real-world view. In this manner, the lens stack assembly reduces the amount of the ambient light provided to the user while the display light (i.e., from the projection system) remains largely unaffected. In some embodiments, the first lens (i.e., the world-side lens) includes a tint to absorb light that is outcoupled from the waveguide in a direction away from the user. In this manner, the lens stack assembly reduces or eliminates the generation of ghost images, thereby improving the quality of the image delivered to the user.

In some embodiments, the projector is a digital light processing-based projector, a scanning laser projector, or any combination of a modulative light source such as a laser or one or more LEDs and a dynamic reflector mechanism such as one or more dynamic scanners or digital light processors. In some embodiments, the projector includes multiple laser diodes (e.g., a red laser diode, a green laser diode, and/or a blue laser diode) and at least one scan mirror (e.g., two one-dimensional scan mirrors, which may be microelectromechanical system (MEMS)-based or piezo-based). The projector is communicatively coupled to the controller and a non-transitory processor-readable storage medium or memory storing processor-executable instructions and other data that, when executed by the controller, cause the controller to control the operation of the projector. In some embodiments, the controller controls a scan area size and scan area location for the projector and is communicatively coupled to a processor (not shown) that generates content to be displayed at the display system 100. The projector scans light over a variable area, designated the FOV area 106, of the display system 100. The scan area size corresponds to the size of the FOV area 106, and the scan area location corresponds to a region of one of the lens elements 108, 110 at which the FOV area 106 is visible to the user. Generally, it is desirable for a display to have a wide FOV to accommodate the outcoupling of light across a wide range of angles. Herein, the range of different user eye positions that will be able to see the display is referred to as the eyebox of the display.

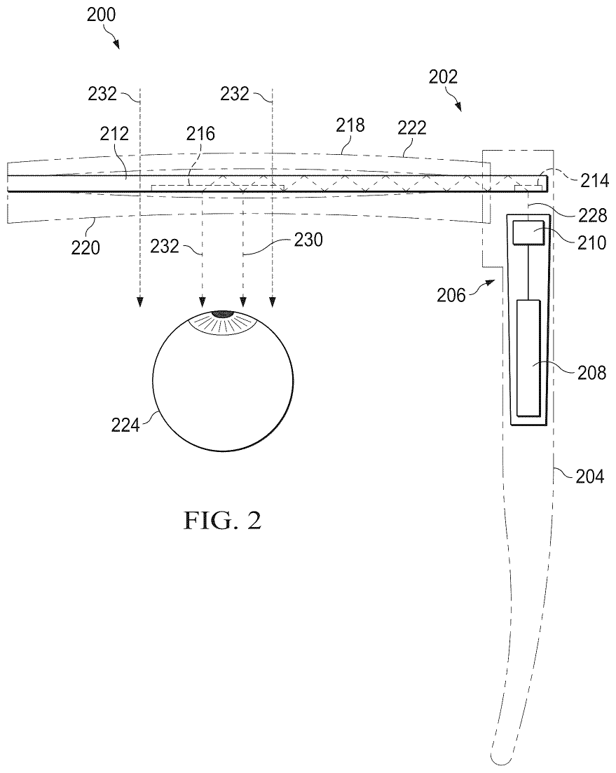

FIG. 2 illustrates a portion of a display system 200 that includes a projection system having a projector 206 and a waveguide 212 that is disposed in an optical combiner lens 218 and that includes an incoupler 214 and an outcoupler 216. In some embodiments, the display system 200 represents the display system 100 of FIG. 1. In the present example, the arm 204 of the display system 200 houses the projector 206, which includes an optical engine 208 (e.g., laser or a display panel), one or more optical elements 210, the incoupler 214, and a portion of the waveguide 212.

The optical combiner lens 218 includes a lens stack assembly including an eye-side lens 220, a world-side lens 222, and the waveguide 212. The waveguide 212 is embedded or otherwise disposed between the eye-side lens 220 and the world-side lens 222. Display light 228 is incoupled into the waveguide 212 at the incoupler 214 and exits as display light 230 through the outcoupler 216 and travels through the eye-side lens 220 (which corresponds to, for example, a portion of an embodiment of the lens element 110 of the display system 100). In use, the display light 230 exiting the ES lens 220 enters the pupil of an eye 224 of a user wearing the display system 200, causing the user to perceive a displayed image carried by the light output by the optical engine 208. The optical combiner lens 218 is substantially transparent, such that light from real-world 232 (i.e., ambient light) corresponding to the environment around the display system 200 passes through the world-side lens 222, the waveguide 212, and the eye-side lens 220 to the eye 224 of the user. In this way, images or other graphical content output by the projector 206 are combined (e.g., overlayed) with real-world images of the user's environment when projected onto the eye 224 of the user to provide an AR experience to the user.

In some embodiments, one or more tints (e.g., surface coating tints or bulk constant density tints) are applied to one or both of the world-side lens 222 and the eye-side lens 220. In some embodiments, a tint applied to the world-side lens 222 is absorptive and mitigates or prevents reflection of outcoupled light from the waveguide 212 back toward the eye 224 of the user to reduce or eliminate the generation of ghost images. In some embodiments, a tint applied to the eye-side lens 220 is selectively transmissive, such that wavelengths of light (e.g., green, red, and blue wavelengths of light) used to display images in the display system 200, such as those corresponding to display light 230 are transmitted via the tint, while other wavelengths of light, such as those corresponding to ambient light 232, are blocked (i.e., reflected or absorbed) by the tint.

The waveguide 212 of the display system 200 includes the incoupler 214 and the outcoupler 216. In some embodiments, one or more exit pupil expanders, such as a diffraction grating, is arranged in an intermediate stage between incoupler 214 and outcoupler 216 to receive light that is coupled into waveguide 212 by the incoupler 214, expand the light received at each exit pupil expander, and redirect that light towards the outcoupler 216, where the outcoupler 216 then couples the light 230 out of waveguide 212 (e.g., directly toward the eye 224 of the user). In some embodiments, the waveguide 212 is configured to have a peak frequency response at a wavelength of green light, such as around 575 nm, which improves perceptibility of projected images output by the waveguide 212.

The term “waveguide,” as used herein, will be understood to mean a combiner using one or more of total internal reflection (TIR), specialized filters, or reflective surfaces, to transfer light from an incoupler (such as the incoupler 214) to an outcoupler (such as the outcoupler 216). In some display applications, the light is a collimated image, and the waveguide transfers and replicates the collimated image to the eye. In general, the terms “incoupler” and “outcoupler” will be understood to refer to any type of optical grating structure, including, but not limited to, diffraction gratings, holograms, holographic optical elements (e.g., optical elements using one or more holograms), volume diffraction gratings, volume holograms, surface relief diffraction gratings, or surface relief holograms. In some embodiments, a given incoupler or outcoupler is configured as a transmissive grating (e.g., a transmissive diffraction grating or a transmissive holographic grating) that causes the incoupler or outcoupler to transmit light and to apply designed optical function(s) to the light during the transmission. In some embodiments, a given incoupler or outcoupler is a reflective grating (e.g., a reflective diffraction grating or a reflective holographic grating) that causes the incoupler or outcoupler to reflect light and to apply designed optical function(s) to the light during the reflection. In the present example, the incoupler 214 relays received light 228 to the outcoupler 216 via one or more optical paths through the waveguide 212. The light propagates through the waveguide 212 via TIR. The outcoupler 216 then outputs the light 230 to the eye 224 of the user.

In some embodiments, the projector 206 is coupled to a driver or other controller (not shown), which controls the timing of emission of light from light sources (e.g., LEDs) of the optical engine 208 in accordance with instructions received by the controller or driver from a computer processor (not shown) coupled thereto to modulate the output light to be perceived as images when output to the retina of the eye 224 of the user. For example, during operation of the display system 200, the light sources of the optical engine 208 output light of selected wavelengths, and the output light is directed to the eye 224 of the user via the optical elements 210 and the waveguide 212. The optical engine 208 modulates the respective intensities of each light source of the optical engine 208, such that the output light represents pixels of an image. For example, the intensity of a given light source or group of light sources of the optical engine 208 corresponds to the brightness of a corresponding pixel of the image to be projected by the projector 206 of the display system 200.

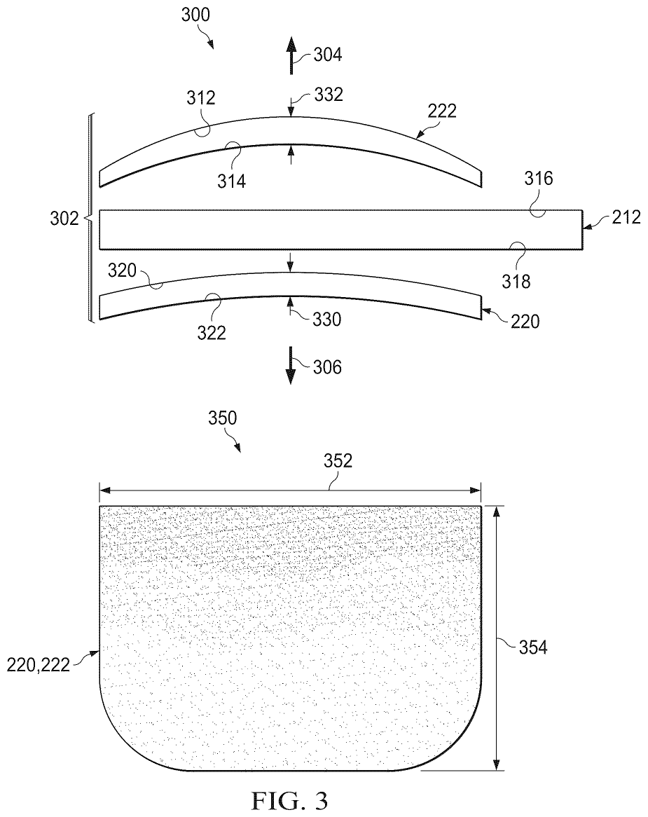

FIG. 3 shows a top-side view 300 of a lens stack assembly 302 and a world or eye side view 350 of the world-side lens 222 or the eye-side lens 220 in accordance with some embodiments. In some embodiments, the lens stack assembly 302 corresponds to the optical combiner lens 218 of FIG. 2 or the lens elements 108, 110 of FIG. 1.

The lens stack assembly 302 includes the waveguide 212 disposed between a first lens 222 and a second lens 220. The first lens 222 is a world side lens facing a world side direction 304 and the second lens 220 is an eye-side lens facing a user direction 306. The first lens 222 includes a first major surface 312 facing the world-side direction 304 and a second major surface 314 facing the waveguide 212. The waveguide 212 includes a first major surface 316 facing the first lens 222 and a second major surface 318 facing the second lens 220. The second lens 220 includes a first major surface 320 facing the waveguide 212 and a second major surface 322 facing the user direction 306. For purposes of this disclosure, the major surfaces 312, 314, 316, 318, 320, 322 are referred to as S1, S2, S3, S4, S5, S6, respectively. For example, the first major surface 312 of the first lens 222 is S1 and the second major surface 322 of the second lens 220 is S6 with the corresponding major surfaces in between numbered in increasing manner from S2 to S5. In addition, the thickness of each of the first lens 222 and the second lens 220 is referred to as the distance between each of their respective major surfaces.

Referring to the tinting of the second lens 220, in some embodiments, the second lens 220 is tinted so light associated with a first optical characteristic has a first level of light transmission (that is, transmits a first amount of light corresponding to the first level) and light associated with other optical characteristics has a second, lower level of light transmission (that is, transmits a second amount of light corresponding to the second, lower level). In some embodiments, the light associated with the first optical characteristic is light associated with a display light. In some embodiments, the first optical characteristic corresponds to a particular wavelength range such as a particular wavelength of red, green, or blue light associated with the display light. For example, in some embodiments, the tint is a gray, violet, blue, green, amber, yellow, orange, or other type of colored tint that is wavelength selective. In other embodiments, the first optical characteristic corresponds to a polarization state. For example, the first optical characteristic is a vertical polarization state, and the display light is vertically polarized. Accordingly, in some embodiments, the tint is a polarization-state selective tint, e.g., applied as a surface coating. In some embodiments, the first level of light transmission corresponds to allowing substantially all the light of that optical characteristic to pass through. For example, the first level of light transmission corresponds to a high visible light transmission (VLT) value such as 80% or higher. The second, lower level of light transmission corresponds to allowing less light to pass through than the first level of light transmission. In other words, the second level of light transmission corresponds to a lower VLT value than the first level of light transmission. For example, this lower VLT value corresponds to a value between 43%-80%, or 18%-43%, or lower than 18%. In some embodiments, the light associated with other optical characteristics corresponds to ambient light, e.g., light entering the lens stack assembly from the world-side direction 304.

In some embodiments, the tint in the second lens 220 is more absorptive to light associated with the other optical characteristics than light associated with the first characteristic. That is, the tint has a higher rate of absorption of light not associated with the first optical characteristic. For example, the tint transmits light (i.e., does not absorb) with a first wavelength range associated with the display light and absorbs, at least partially, light with a second wavelength range that is different from the first wavelength range. In other embodiments, the tint in the second lens 220 is more reflective to light associated with the other optical characteristics than light associated with the first characteristic. That is, the tint has a higher rate of reflection of light not associated with the first optical characteristic. For example, the tint transmits light (i.e., does not reflect) with a first wavelength range associated with the display light and reflects, at least partially, light with a second wavelength range that is different from the first wavelength range.

In some embodiments, the tint is applied to the second lens 220 as a surface coating. That is, the tint is applied to either or both of first major surface 320 (i.e., S5) or second major surface 322 (i.e., S6). In other embodiments, the tint is applied to the second lens 220 as a bulk density tint. That is, the tint is incorporated into the substrate of the second lens 220.

In some embodiments, the tint in the second lens 220 is applied as a gradient tint. For example, in the case of a surface coating tint, the gradient tint gradually changes along a first direction of a major surface of the second lens 220. In some embodiments, the first direction corresponds to a vertical direction 354 or a horizontal direction 352 of the corresponding major surface of the second lens 220. In another embodiment, the first direction corresponds to a diagonal direction, e.g., from the top left corner to the bottom right corner shown in view 350. For example, as illustrated in view 350 for second lens 220, the gradient tint is applied in the vertical direction 354 and is darker from top to bottom. In another example, in the case of a bulk density tint, the gradient tint gradually changes along a thickness direction 330 of the second lens 220. This thickness direction 330 corresponds to the direction between the first major surface 320 and the second major surface 322 of the second lens 220.

In some embodiments, the tint in the second lens 220 is photochromic or electrochromic. In some embodiments, the second level of light transmission changes based on one or more environmental factors. In the case of photochromic tint, for example, the tint becomes darker (i.e., less transmissive) to light of the associated with the other optical characteristics in brighter-light situations. For example, the characteristics of the tint changes to block a higher level of ambient light when outside in sunny weather and blocks a lower level when indoors.

Referring to the tinting of the first lens 222, in some embodiments, the first lens 222 is tinted so light outcoupled from the waveguide 212 is absorbed by the first lens 222. During operation, the waveguide 212 outcouples a first (and principal) portion of the display light in a direction of a user 306 but may outcouple a second (and smaller) portion of the display light in a direction away from the user, e.g., towards world-side direction 304. Accordingly, the first lens 222 is tinted to absorb, and not reflect, this light. For example, the display light has a specific wavelength or wavelength range, and the tint of the first lens 222 absorbs light associated with this particular wavelength or wavelength range. Accordingly, the reflection of this second portion of display light back in the direction of the user 306 is mitigated or eliminated altogether, thereby reducing or eliminating ghost images projected to the user. In some embodiments, the tint applied to the second lens 222 additionally at least partially blocks ambient light coming in from the world-side direction 304. Accordingly, the tint applied to the first lens 222 additionally reduces the amount of ambient light transmitted to the user.

In some embodiments, the tint is applied to the first lens 222 as a surface coating. That is, the tint is applied to either or both of first major surface 312 (i.e., S1) or second major surface 314 (i.e., S2). In other embodiments, the tint is applied to the first lens 222 as a bulk density tint. That is, the tint is incorporated into the substrate of the first lens 222.

In some embodiments, the tint in the first lens 222 is applied as a gradient tint. For example, in the case of a surface coating tint, the gradient tint gradually changes along a first direction of a major surface of the first lens 222. In some embodiments, the first direction corresponds to a vertical direction 354 or a horizontal direction 352 of the corresponding major surface of the first lens 222. In another embodiment, the first direction corresponds to a diagonal direction, e.g., from the top left corner to the bottom right corner shown in view 350. In another example, in the case of a bulk density tint, the gradient tint gradually changes along a thickness direction 332 of the first lens 222. This thickness direction 332 corresponds to the direction between the first major surface 312 and the second major surface 314 of the first lens 222. For example, the tint is more concentrated (e.g., less transmissible to light of the respective characteristic) at major surface 314 than at major surface 312.

In some embodiments, the tint applied to the first lens 222 is photochromic or electrochromic, where the level of light absorption of the light received from the waveguide 212 changes based on one or more environmental factors. In the case of photochromic tint, for example, the tint becomes more absorptive to light associated with the display light in scenarios that may be more susceptible to ghost images. For example, the tint changes to be more absorbent of the display light in a darkened room.

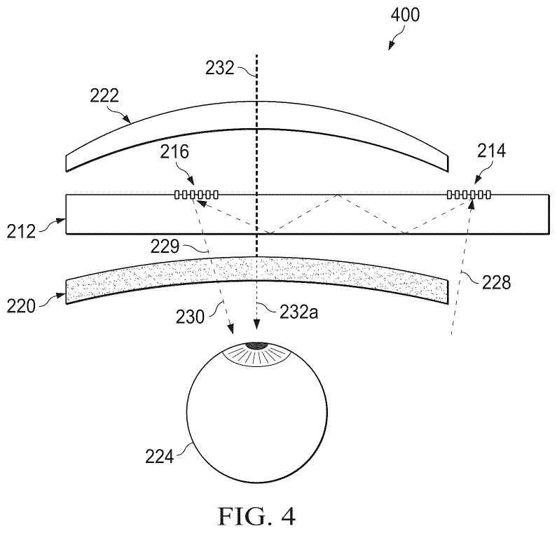

FIG. 4 shows an embodiment of a lens stack assembly 400 illustrating the effects of a selectively transmissive tint in the second lens 220. In some embodiments, the lens stack assembly 400 corresponds to the lens stack assembly 302 of FIG. 3, the optical combiner lens 218 of FIG. 2, and/or one or both of the lens elements 108, 110 of FIG. 1.

The selectively transmissive tint in the second lens 220 at least partially blocks (e.g., absorbs or reflects) the ambient light 232 passing through the second lens 220 so a reduced amount of ambient light 232a is observed by the user and transmits the display light outcoupled from the outcoupler 216 (229 to 230). In some embodiments, the selective transmissive tint in the second lens 220 has a first level of light transmission for light with a first optical characteristic associated with the display light and a lower, second level of light transmission for light with other optical characteristics. For example, the selectively transmissive tint of the second lens 220 is substantially transmissive to a first set of wavelengths of light (e.g., wavelengths associated with the display light, such as a particular red, green, and/or blue wavelengths) and at least partially blocks other wavelengths. In another example, the selectively transmissive tint of the second lens 220 is substantially transmissive to a first polarization state (e.g., vertically polarized light) and blocks other polarization states (e.g., horizontally polarized light). In either case, the display light 229, 230 is substantially not affected by the tint in second lens 220 while ambient light that passes through the second lens 220 is reduced 232a.

In some embodiments, the tint of the second lens 220 shown in lens stack assembly 400 is a bulk constant density tint or a surface coating. In some embodiments, the tint of the second lens 220 shown in lens stack assembly 400 is a gradient tint. In some embodiments, the tint of the second lens 220 shown in lens stack assembly 400 is a photochromic or electrochromic tint.

During operation of an example display system 100 such as a WHMD that includes the lens stack assembly 400, the waveguide 212 receives display light 228 at incoupler 214 and redirects it toward the outcoupler 216 through the waveguide via one or more instances of TIR. The outcoupler 216 redirects the display light 229 out of the waveguide 212. This display light 229 goes through the second lens 220 toward the eye 224 and is observed by the user as display light 230. Ambient light 232 passes through the lens stack assembly 400, including the first lens 222, the waveguide 212, and the second lens 220, toward the eye 224 as ambient light 232a. Because the tint of the second lens 220 is configured to transmit light of a first optical characteristic (e.g., wavelength range) associated with the display light (e.g., 228, 229), the intensity of the display light before 229 and after 230 it passes through the lens is substantially the same. However, the tint in the second lens 220 reduces the intensity of the ambient light as shown in 232a. This reduction in intensity is demonstrated by the narrower dashed line at 232a after passing through the second lens 220. Because the tint in the second lens 220 is substantially transmissive to the display light and at least partially blocks the ambient light, the intensity (i.e., brightness) of the display light passing through the second lens 220 is largely unaffected while the intensity of the ambient light is reduced. Accordingly, the quality of the image associated with the display light is improved.

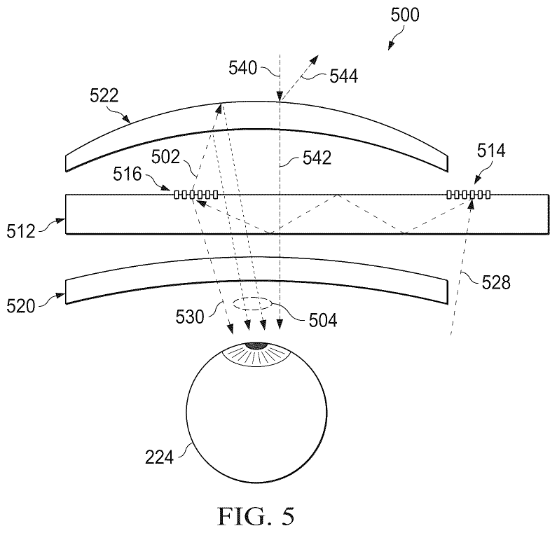

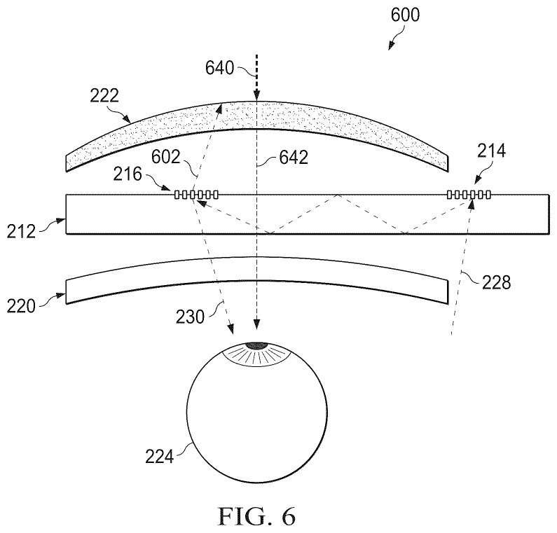

FIG. 5 illustrates the effects of a ghost image scenario in a lens arrangement 500. FIG. 6 illustrates the effects of a lens stack assembly 600 that mitigates or minimizes the generation of ghost images in accordance with some embodiments.

In FIG. 5, the first lens 522 in the lens stack assembly 500 includes a conventional reflective tint to reflect at least a portion 544 of the ambient light 540 at the first lens 522. For example, ambient light 540 is received at the first lens 522, and a first portion 542 of it is transmitted through while a second portion 544 is reflected. Accordingly, the first lens 522 with a reflective tint reduces the amount of ambient light passed to the eye 224 of the user. However, the conventional reflective tint in the first lens 522 also reflects a portion of the outcoupled light 502 from the outcoupler 516 back toward the eye 224 as reflected outcoupled light 504.

During operation of a system with the lens arrangement 500, the waveguide 512 receives display light 528 at the incoupler 514 and outcouples a first portion of the light 530 at the outcoupler 516 in the direction of the user 224. However, a second portion of the outcoupler light 502 is outcoupled away from the user 224. For a conventional system in which the first lens 522 has a reflective tint, the second portion of outcoupled light 502 is reflected back toward the user as reflected outcoupled light 504. This reflected outcoupled light 504 results in the user perceiving ghost images, which negatively impacts the quality of the image perceived by the user. The lens stack assembly 600 shown in FIG. 6 reduces or eliminates the generation of ghost images.

FIG. 6 shows an embodiment of a lens stack assembly 600 illustrating the effects of a tint in the first lens 222 to absorb outcoupled light from the waveguide 212. In some embodiments, the lens stack assembly 600 corresponds to the lens stack assembly 302 of FIG. 3, the optical combiner lens 218 of FIG. 2, and/or one or both of the lens elements 108, 110 of FIG. 1.

The absorptive tint in the first lens 222 absorbs light with a first optical characteristic associated with the display light 228. For example, the first optical characteristic includes a particular wavelength or wavelength range. In this manner, the portion of light 602 that is outcoupled at the outcoupler 216 away from the user 224 is absorbed rather than reflected by the first lens 222 (e.g., compared to FIG. 5, where the portion of outcoupled light 502 is reflected back as reflected outcoupled light 504). Thereby, the generation of ghost images is mitigated or eliminated altogether. In some embodiments, the absorptive tint in the first lens 222 also at least partially blocks (e.g., absorbs) ambient light 640 so as to reduce the intensity or brightness of the ambient light (shown in 642) that is transmitted to the user.

In some embodiments, the tint of the first lens 222 of lens stack assembly 600 is a bulk constant density tint or a surface coating. In some embodiments, the tint of the first lens 222 of lens stack assembly 600 is a gradient tint. In some embodiments, the tint of the first lens 222 of lens stack assembly 600 is a photochromic or electrochromic tint.

During operation of an example display system 100 such as a WHMD that includes the lens stack assembly 600, display light 228 is incoupled into the waveguide 212 at incoupler 214 and redirected in the direction of the outcoupler 216 through the waveguide 212 via multiple instances of TIR. The display light 228 has a first optical characteristic such as a particular wavelength or wavelength range. At the outcoupler 216, a first portion of the display light 230 is outcoupled directly toward the eye 224 of the user. However, a second portion of the display light 602 may be outcoupled in the wrong direction, i.e., away from the eye 224 of the user. Instead of reflecting this outcoupled light 602, the absorptive tint in the first lens 222 absorbs this second portion of outcoupled light 602. Accordingly, the absorptive tint in the first lens 222 eliminates the generation of ghost images. Thus, degradation of quality of images displayed via the lens assembly due to ghost images is mitigated or eliminated.

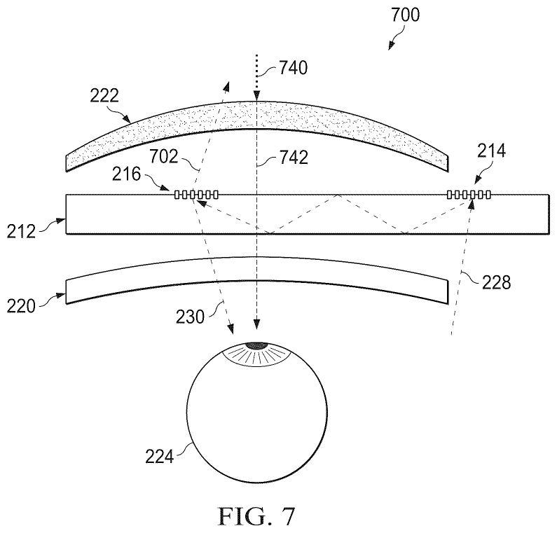

FIG. 7 shows an embodiment of a lens stack assembly 700 illustrating the effects of a polarization-selective tint in the first lens 222 to transmit outcoupled light 702 from the waveguide 212 and block at least a portion of the ambient light 740. In some embodiments, the lens stack assembly 700 corresponds to the lens stack assembly 302 of FIG. 3, the optical combiner lens 218 of FIG. 2, and/or one or both of the lens elements 108, 110 of FIG. 1.

The polarization-selective tint in the first lens 222 transmits light with a first polarization state associated with the display light 228 and blocks light with other polarization states. For example, the display light is vertically polarized light, and the polarization-selective tint in the first lens 222 transmits vertically polarized light and blocks light with other polarization states, e.g., horizontally polarized light. Accordingly, the generation of ghost images resulting from the reflection of the second portion of outcoupled light 702 is eliminated while the amount of ambient light 740 that passes through the first lens 222 is also reduced 742.

During operation of an example display system 100 such as a WHMD that includes the lens stack assembly 700, the display light 228 is incoupled into the waveguide 212 at incoupler 214 with a first polarization state (e.g., vertical polarization) and redirected in the direction of the outcoupler 216 through the waveguide 212 via multiple instances of TIR. At the outcoupler 216, a first portion of the display light 230 is outcoupled directly toward the eye 224 of the user. However, a second portion of the display light 702 may be outcoupled in the wrong direction, i.e., away from the eye 224 of the user. The polarization-selective tint in the first lens 222 transmits this second portion of outcoupled light 702 (i.e., this light passes through unaffected) since the second portion of outcoupled light 702 is vertically polarized. Accordingly, the reflection of this second portion of the second portion of outcoupled light 702 back toward the eye 224 of the user is mitigated or eliminated. However, the polarization-selective tint in the first lens 222 blocks at least a portion of the ambient light 740 so that a reduced amount of ambient light 742 passed through the first lens 222. Thus, degradation of quality of images displayed via the lens assembly 700 due to ghost images is mitigated or altogether avoided due to the inclusion of a polarization-selective tint at the first lens 222 and the selective polarization of the display light 228. Additionally, the amount of ambient light 740 that is transmitted to the eye 224 of the user is also reduced. This improves the quality of the images displayed to the user.

FIG. 8 shows a flowchart 800 illustrating an example method to control light in a WHMD in accordance with some embodiments. In some embodiments, the WHMD includes a lens stack assembly with a waveguide disposed between a world-side lens and an eye-side lens. At 802, the method includes incoupling display light at an incoupler of the waveguide. At 804, the method includes outcoupling a first portion of the incoupled display light to a user through the eye-side lens. At 806, the method includes absorbing a second portion of the incoupled display light at the world-side lens. For example, in some embodiments, an absorptive tint at the world-side lens is wavelength specific to correspond to a specific wavelength associated with the display light. Accordingly, the generation of ghost images is reduced or eliminated altogether. In some embodiments, the absorptive tint also at least partially blocks (e.g., absorbs) ambient light. Accordingly, the amount of ambient light observed by the user is reduced.

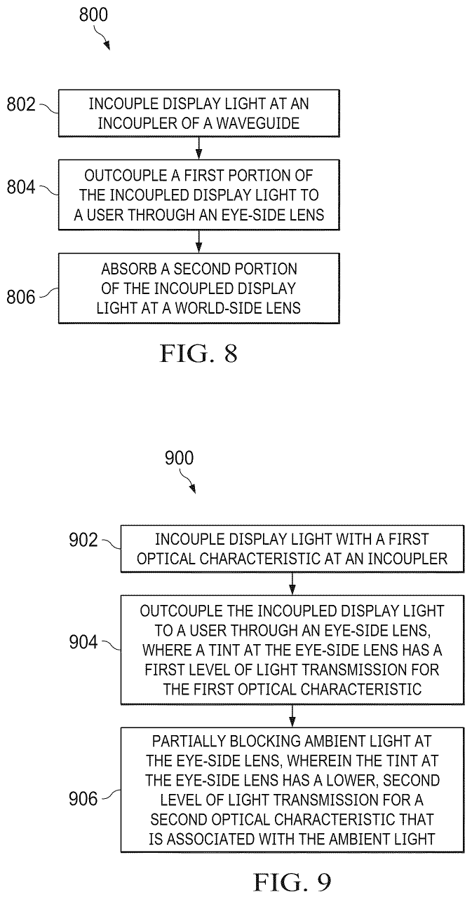

FIG. 9 shows a flowchart 900 illustrating an example method to control light in a WHMD in accordance with some embodiments. In some embodiments, the WHMD includes a lens stack assembly with a waveguide disposed between a world-side lens and an eye-side lens. At 902, the method includes incoupling display light with a first optical characteristic at an incoupler. At 904, the method includes outcoupling the incoupled display light to a user through the eye-side lens, wherein a tint at the eye-side lens has a first level of light transmission for the first optical characteristic. At 906, the method includes partially blocking ambient light from an external source of the WHMD at the eye-side lens, wherein the tint at the eye-side lens has a lower, second level of light transmission for a second optical characteristic that is associated with the ambient light. For example, in some embodiments, the first optical characteristic is a particular wavelength or wavelength range. In other embodiments, the first optical characteristic is a polarization state. Accordingly, the amount of ambient light that is transmitted to the user is reduced while the display light remains unaffected.

In some embodiments, the tints described in the present disclosure are applied as a surface coating tint, a bulk density tint, or any combination thereof. In some embodiments, the tints described in the present disclosure are applied as gradient tints. In some embodiments, the tints described in the present disclosure are photochromic or electrochromic tints.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A lens stack assembly comprising:
a waveguide disposed between a first lens and a second lens, the waveguide configured to incouple display light at an incoupler and outcouple the display light at an outcoupler,
wherein a tint at the second lens has a first level of light transmission for light with a first optical characteristic associated with the display light and a lower, second level of light transmission for light with a second optical characteristic.

2. The lens stack assembly of claim 1, wherein the first optical characteristic comprises a first wavelength range and the second optical characteristic comprises wavelengths outside of the first wavelength range.

3. The lens stack assembly of claim 1, wherein the first optical characteristic comprises a first polarization state and the second optical characteristic comprise a second polarization state different than the first polarization state, and wherein the tint is polarization selective to transmit light with the first polarization state and block light with the second polarization state.

4. The lens stack assembly of claim 1, wherein the tint comprises a bulk tint incorporated into a substrate of the first lens.

5. The lens stack assembly of claim 1, wherein the tint comprises a surface coating tint applied to a major surface of the first lens.

6. The lens stack assembly of claim 4, wherein the tint comprises a gradient tint with a gradient along a first direction on the major surface of the first lens or in a second direction traversing a thickness of the first lens.

7. The lens stack assembly of claim 1, wherein the tint comprises a photochromic tint or an electrochromic tint.

8. The lens stack assembly of claim 7, wherein the tint changes based on one or more environmental factors to alter the second level of light transmission.

9. The lens stack assembly of claim 1, wherein the first lens is configured as a world-side lens, and the second lens is configured as an eye-side lens to be closer to a user than the first lens.

10. The lens stack assembly of claim 1, wherein the second optical characteristic is associated with ambient light from a source external to a wearable head mounted display (WHMD) comprising the lens stack assembly.

11. A lens stack assembly comprising:
a waveguide disposed between a first lens and a second lens, the waveguide configured to incouple display light at an incoupler and outcouple the display light at an outcoupler, wherein the first lens is a world-side lens and the second lens is a user eye-side lens,
wherein the first lens comprises a tint to absorb light received from the waveguide.

12. The lens stack assembly of claim 11, wherein the tint absorbs light with a first optical characteristic associated with the display light.

13. The lens stack assembly of claim 12, wherein the first optical characteristic is a first wavelength range.

14. The lens stack assembly of claim 11, wherein the tint at least partially blocks light with a second optical characteristic that is not associated with the display light.

15. The lens stack assembly of claim 14, wherein the at least partially blocking of light with the second optical characteristic comprises reflecting or absorbing.

16. The lens stack assembly of claim 14, wherein the second optical characteristic is associated with ambient light entering the lens stack assembly via the first lens.

17. The lens stack assembly of claim 11, wherein the tint comprises a bulk tint incorporated into a substrate of the first lens.

18. The lens stack assembly of claim 11, wherein the tint comprises a surface coating tint applied to a major surface of the first lens.

19. The lens stack assembly of claim 17, wherein the tint comprises a gradient tint with a gradient along a first direction on the major surface of the first lens or in a second direction traversing a thickness of the first lens.

20. The lens stack assembly of claim 11, wherein the tint comprises a photochromic tint or an electrochromic tint, wherein the second level of light transmission changes based on one or more environmental factors.

21. A method to control light in a wearable head-mounted display (WHMD) comprising a lens stack assembly with a waveguide disposed between a world-side lens and an eye-side lens, the method comprising:
incoupling display light at an incoupler of the waveguide;
outcoupling a first portion of the incoupled display light to a user through the eye-side lens; and
absorbing a second portion of the incoupled display light at the world-side lens.

22. The method of claim 21, wherein a tint at the world-side lens absorbs light with a first optical characteristic associated with the display light.

23. The method of claim 22, wherein the first optical characteristic is a wavelength range, and wherein the tint is further configured to at least partially block light with a second optical characteristic comprising a second wavelength range associated with an ambient light from a source external to the WHMD.

24. A method to control light in a wearable head-mounted display (WHMD) comprising a lens stack assembly with a waveguide disposed between a world-side lens and an eye-side lens, the method comprising:
incoupling display light with a first optical characteristic at an incoupler;
outcoupling the incoupled display light to a user through the eye-side lens, wherein a tint at the eye-side lens has a first level of light transmission for the first optical characteristic; and
at least partially blocking ambient light from an external source of the WHMD at the eye-side lens, wherein the tint at the eye-side lens has a second level of light transmission, lower than the first level of light transmission, for a second optical characteristic that is associated with the ambient light.
